(19) United States
(12) Patent Application Publication
(10) Pub. No.: US 2014/0220449 A1
(43) Pub. Date: Aug. 7, 2014

(54) LITHIUM BASED ANODE WITH NANO-COMPOSITE STRUCTURE AND METHOD OF MANUFACTURING SUCH

(71) Applicant: Johnson IP Holding, LLC, Atlanta, GA (US)

(72) Inventors: Davorin Babic, Marietta, GA (US); Lonnie G Johnson, Atlanta, GA (US); William L Rauch, Douglasville, GA (US); Joykumar Thokchom, Atlanta, GA (US)

(21) Appl. No.: 14/246,923

(22) Filed: Apr. 7, 2014

Related U.S. Application Data
(63) Continuation-in-part of application No. 13/412,265, filed on Mar. 5, 2012.

(51) Int. Cl. H01M 4/36; H01M 4/04; H01M 4/1395; H01M 4/02

(52) U.S. Cl. CPC H01M 4/364; H01M 4/02; H01M 4/04; H01M 4/1395; H01M 2004/021
USPC 429/231.6; 429/231.95; 264/45.3; 264/42

(57) ABSTRACT

An active anode (10) is provided that includes a framework (11) of a first anodic material which contains large cavities (12) that include particles (13) of a second anodic material. The cavities have to be large enough so that a fully lithiated particles of the second anodic material fits into the cavity that contains it and does not apply stress to the framework. The first anodic material has a lower lithiation/delithiation potential than the second anodic material. To produce the anode cavities the second anodic material is coated with an organic coating which is then removed once the anodic layer is produced from a mixture of the first and second anodic materials.

### REFERENCE TO RELATED APPLICATION

This is a continuation in part of U.S. patent application Ser. No. 13/412,265 filed Mar. 5, 2012.

### TECHNICAL FIELD

This invention relates generally to batteries, and more particularly to the anode of a battery and the method of manufacturing such.

### BACKGROUND OF THE INVENTION

Batteries typically include a cathode, an anode and an electrolyte. One problem associated with lithium batteries has been that high storage capacity lithium battery anode materials expand over 100% when fully lithiated. This expansion of the anode causes disintegration of anode structure by cracking. The cracking severely reduces the performance of the anode and the associated batteries that contain such anode, thus limiting commercial applicability of the lithium based battery technology. An additional problem is associated with the use of lithium based anodes in combinations with liquid electrolytes. As lithium plates at the anode during recharge of a conventional electrochemical cell that employs liquid electrolyte, lithium appearing at the surface of active materials within the anode can react with the liquid electrolyte before being intercalated. Such parasitic reactions can result in not only consumption of the lithium and thereby a reduction in storage capacity of the cell because less lithium is available for cycling between the anode and cathode; but it can also result in a passivation coating on the surface of the active material which can result in an increase in cell impedance.

It thus is seen that a need remains for a battery anode which overcomes problems associated with those of the prior art. Accordingly, it is to the provision of such that the present invention is primarily directed.

### SUMMARY OF THE INVENTION

In a preferred form of the invention, a battery anode comprises a base made of a first anodic material having a lithiation/delithiation potential, and a plurality of particles made of a second anodic material having a lithiation/delithiation potential that is different from the lithiation/delithiation potential of the first material. Each particle of the plurality of particles being encapsulated within a cavity within the base. The first anodic material has high electronic conductivity and high lithium diffusivity.

In another preferred form of the invention, a method of producing a battery anode comprises the steps of preparing a quantity of a first anodic material having a first lithiation/delithiation potential, preparing a quantity of a particulated second anodic material having a second lithiation/delithiation potential that is different from said first lithiation/delithiation potential of said base first anodic material, coating the particles of the second anodic material with a removable coating, mixing the second anodic material into the first anodic material to form a mixture of anodic materials, forming an anodic layer with the mixture of anodic materials, and removing the coating from the particles of the second anodic material within the anodic layer so as to form a cavity about the particles of the second anodic material in the area once occupied by the removed coating.

### BRIEF DESCRIPTION OF THE DRAWINGS

FIG. 1 is a cross-sectional view of an anode in a preferred form of the invention.

FIG. 2 is a table showing properties of anodic materials.

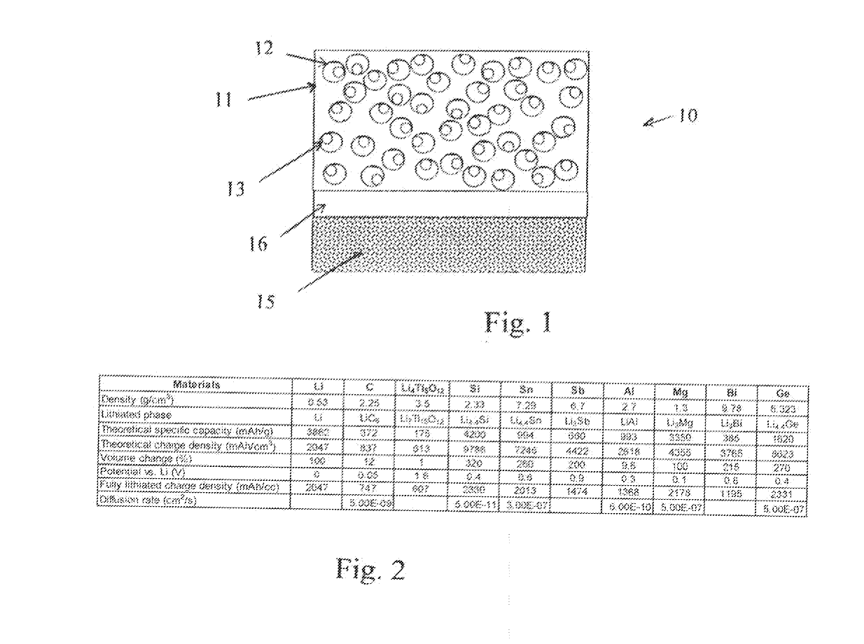

### DETAILED DESCRIPTION

With reference next to the drawings, a dimensionally stable lithium based anode is disclosed having a composite structure that includes internal space for expansion and contraction of electrochemically active electrode material. This invention is targeted particularly to lithium based anodes.

Lithium has a very high columbic capacity at 2047 mAh/cm³. To avoid plating and stripping of pure lithium, lithium reactive anode materials have been identified that have comparably high volumetric capacity. A selection of such materials is listed in FIG. 2. Considering two examples, magnesium has a lithium capacity of 4355 mAh/cm³ with a volumetric expansion change of 100% with the lithiation/delithiation of lithium (lithiated). The fully lithiated volumetric capacity of magnesium is 2178 mAh/cm³. On the other hand germanium has a capacity of 8623 mAh/cm³ with a volumetric expansion change of 270% fully lithiated resulting in the germanium fully lithiated volumetric capacity of 2331 mAh/cm³.

The active anode 10 of the present invention consists of two anodic materials. One of the materials will be implemented as a structural matrix for supporting the second material. The second material is preferably in powder form and contained within oversized cavities within the first material. The first material should have good electronic conductivity and high lithium diffusivity. Magnesium and germanium are believed to be the preferred materials of the present invention. The anode 10 consists of a base or framework 11 of a first anodic material, preferably magnesium, which contains cavities 12 that include micron or submicron sized powder or particles (particulated) 13 of a second anodic material (which may be referred to herein as nano-powder), preferably germanium, although magnesium of a particle size of 30 to 40 microns is available today from Afla Aesar and US Research Nanomaterials, Inc. which is believed to be capable to working. The cavities should be large enough so that a fully lithiated nano-particle of the germanium material fits into or within the cavity 12 that contains it and does not apply significant stress to the framework. The first anodic material (magnesium) is the material with a lower lithium tithiation/delithiation potential with respect to lithium, while the second anodic material (germanium) has a higher lithium lithiation/delithiation potential. Magnesium has a potential of 0.1V while germanium has a potential of 0.3 to 0.4V. The magnesium is the material in contact with the electrolyte 16. It is partially lithiated so in order to achieve enhanced lithium diffusion rates. The magnesium and germanium materials are selected because of their high electronic conductivities and a high lithium diffusivities. A high electronic conductivity is believed to be one wherein the electronic resistivity lower than 50 Ohm×cm. Materials such as silicon and aluminum have low diffusion rates; however, they are suitable for use as the second anodic material in the present invention because they can be employed as nano sized particles that would require minimal diffusion distance. Silicon in particular has low electronic conductivity; however, it works as the second anodic material when implemented as small size particles, less than on micron.

An essentially dimensionally stable anode structure is made possible based on the difference in lithiation/delithiation potentials between the two materials. Germanium (second material) has a lithiation/delithiation potential of approximately 0.3V to 0.4V, whereas magnesium (first material) has an lithiation/delithiation potential of only 0.1 volts. Because of the difference in lithiation/delithiation potentials, lithium will preferentially lithiation/delithiation into the germanium. Given the high lithium diffusion rate in the range of 5×10⁻⁷ cm²/sec of magnesium, the lithium will readily diffuse through the magnesium to reach the higher lithiation/delithiation potential germanium. Because the process avoids extended residence time of lithium in the magnesium due to the higher lithiation/delithiation potential of germanium, the level of lithiation of the magnesium remains essentially unchanged by lithium that passes through the magnesium on its was to the germanium and thereby the magnesium maintains relatively stable dimensions within the design capacity limit of the anode electrode.

To produce the anode 10, the nano-particles of the germanium material are coated with an organic or polymer coating such as the polymer ethylene carbonate, i.e., the nano-particles of germanium material are embedded or encapsulated within an organic coating. Other polymer coatings may include PMMA and low molecular weight PEO materials. The volume and diameter of the organic coating mimics the volume expansion of the particle when fully lithiated, i.e., the diameter of the coated particle will generally equal the diameter of the cavity 12 and the diameter of the fully lithiated germanium nano-particle. It should be noted that preferably the cavity size is equal to or greater than the size of the coated particle to prevent stresses upon the framework during expansion. Germanium expands by approximately 270% when fully lithiated. The germanium material nano-particles have a preferred diameter size of approximately 0.07 to 5 microns, thus once lithiated the particles will expand along the diameter by approximately 60%. Germanium of a 0.07 micron size is available from Sky Spring Nanomaterials, inc. Accordingly, a 0.1 size particle should have a coating of approximately 0.03 (0.1 micron+two coatings of 0.03 along the diameter for a total diameter of 0.16 microns). The larger the particle size the thicker the coating material will need to be to provide for the volumetric expansion associated with being lithiated. The organic material coating may be produced by immersing the germanium particles within a melted polymer bath (maintained at about 35 degrees celsius for ethylene carbonate). The resulting material mixture is then solidified by freezing it at the temperature of liquid nitrogen and subsequently ground using a mortar and pestle or other suitable grinding technique to break the frozen contiguos solid into separately coated germanium nanoparticles. A milling process is used to separate the coated nano-particles from each other.

The nano-particles of the germanium material still coated by the solidified polymer are then mixed with particles of the magnesium powder material to form a mixture or composite active anode structure. The resulting composite anode structure is first pressed and then rolled through a roller to tightly bind the particles in order to form a composite layer or slab. The pressed composite layer/slab is then heated at approximately 400 degrees celsius in a vacuum so that the polymer coating is removed by sublimation/evaporation from the germanium nano-particle. The heating is done in a vacume, or alternatively an inert atmosphere, and below temperatures that support significant alloying between the germanium and magnesium materials. The removal of the polymer leaves a space or cavity 12 in the area previously occupied by the polymer coating. As previously stated, the resulting cavity 12 is sized to approximate the enlarged size of the germanium nano-particle once it increases volumetrically as a result of being lithiated.

Alternatively, the anode 10 consists of a base or framework 11 of a third anodic material, preferably germainum, which contains cavities 12 that include micron or submicron sized powder or particles (particulated) 13 of a fourth anodic material (which may be referred to herein as nano-powder), preferably magnesium. The cavities should be large enough so that a fully lithiated nano-particle of the magnesium material fits into or within the cavity 12 that contains it and does not apply significant stress to the framework. The third anodic material (germanium in this case) is the material with a higher lithium lithiation/delithiation potential with respect to lithium, while the second anodic material (magnesium in this case) has a lower lithium lithiation/delithiation potential. Magnesium has a potential of 0 to 0.1V with a plateau at about 0.5V while germanium has a potential of 0 to 0.4V with a plateau around 0.35V. The germanium is the material in contact with the electrolyte 16. It is fully lithiated so in order to achieve enhanced lithium diffusion rates and a lithium reaction potential at 0.1V or less. In this configuration, the anode can be cycled between 0.01V and 0.1V with very little change in volume of the germanium because it already fully lithiated. Lithium will diffuse through the germanium to the magnesium particles within the pores of the germanium.

An essentially dimensionally stable anode structure is made possible based on the difference in lithiation/delithiation potentials between the two materials. Germanium (third material) is fully lithiated well beyond its 0.35V plateau down to a range of 0.05V, whereas magnesium (fourth material) has a lithiation/delithiation plateau in the 0.5V range where it has significant lithiation/delithiation capacity. During cycling, the germanium can accommodate only a small amount of additional lithium as the anode is cycled between about 0.02 and 0.1 volts where a, magnesium has a large capacity in this voltage range. The lithium will diffuse through the germanium and lithiation/delithiation into the magnesium. Given the high lithium diffusion rate in the range of 5×10⁻⁷ cm²/sec of germanium, the lithium will readily diffuse through the germanium under the lithiation/delithiation potential of the magnesium. Because the level of lithiation of the germanium remains essentially unchanged by lithium that passes through the germanium on its was to the magnesium, the germanium, thereby, maintains relatively stable dimensions within the design capacity limit of the anode electrode.

Under this alternative construction, the nano-particles of the magnesium material are coated with an organic coating such as the polymer ethylene carbonate, i.e., the nano-particles of magnesium material are embedded or encapsulated within an organic coating. The volume and diameter of the organic coating mimics the volume expansion of the particle when fully lithiated, i.e., the diameter of the coated particle will generally equal the diameter of the cavity 12 and the diameter of the fully lithiated magnesium nano-particle. It should be noted that preferably the cavity size is equal to or greater than the size of the coated particle to prevent stresses upon the framework during expansion. Magnesium expands by approximately 100% when fully lithiated.

The nano-particles of the magnesium material still coated by the solidified polymer are then mixed with particles of the germanium powder material to form a mixture or composite active anode structure. The resulting composite anode structure is then pressed by being forced through a roller to tightly bind the particles in order to form a composite layer or slab. The pressed composite layer/slab is then heated to remove the polymer coating from the magnesium nano-particles. The heating is done in an inert atmosphere and below temperatures that support significant alloying between the germanium and magnesium materials. The removal of the polymer leaves a space or cavity 12 in the area previously occupied by the polymer coating. As previously stated, the resulting cavity 12 is sized to approximate the enlarged size of the magnesium nano-particle once it increases volumetrically as a result of being lithiated.

Once the anode is produced, it is incorporated into a battery cell having a cathode 15, an electrolyte 16, a cathode anode current collector and an anode current collector. The cathode is made of a lithium intercalation compound. The electrolyte is preferably made of either a solid lithium ion conducting electrolyte such as lithium phosphorus oxynitride, LiₓPO_{y}N_{z}, a lithium lanthanum zirconium oxide (LiLaZrO), a polymer based lithium ion conducting electrolyte, or a liquid lithium ion conducting electrolyte. Finally, an anode current collector and cathode current collector are preferably made of copper or nickel.

It should be understood that the first anodic material which forms the structural matrix of the present invention can lithiate/delithiate which means that it can react with lithium to form and unform a lithium alloying material (alloy). This type of material provides a high electronic conductivity and a high lithium diffusivity (5×10⁻⁷ cm²/s). This type of lithation/delithiation material is very different from the prior art, such as U.S. Patent Application Publication No. 2008/0038638 by Zhang et al. which describes a base material made of polymer, ceramic or hybrid of such materials which are not capable of lithiation/delithiation, i.e., they do not have lithiation/delithiation potential. As such, these materials have a relatively low electronic conductivity and low lithium diffusivity (approximately 1×10⁻¹¹ cm²/s) do not provide the high electronic conductivity and high lithium diffusivity found in the present invention.

It should be understood that as used herein the term particle or each particle may include more than one particle and is not intended to be limited to only one particle, as particles may stick together to form a conglomerate, a particle comprised of multiple pieces or particles, or simply two or more particles in close proximity to each other.

It thus is seen that an anode and method of producing an anode is now provided which restricts the damage associated with the anode being lithiated. It should of course be understood that many modifications may be made to the specific preferred embodiment described herein, in addition to those specifically recited herein, without departure from the spirit and scope of the invention as set forth in the following claims.

1. A battery anode comprising,
a base made of a first anodic material having a first lithiation/delithiation potential, said base having a plurality of oversized cavities, and
a plurality of particles made of a second anodic material having a second lithiation/delithiation potential different from said first lithiation/delithiation potential of said base first anodic material, each said particle of said plurality of particles being positioned within one said cavity of said plurality of cavities,
said first anodic material having a high electronic conductivity and a high lithium diffusivity.

2. The battery anode of claim 1 wherein each said cavity of said plurality of cavities is sized substantially equivalent to or greater than the expanded size of said second anodic material particle positioned therein due to the particle being lithiated.

3. The battery anode of claim 1 wherein said first anodic material is magnesium.

4. The battery anode of claim 3 wherein said second anodic material is germanium.

5. The battery anode of claim 1 wherein said second anodic material is germanium.

6. A battery anode comprising,
a base made of a first anodic material having a low lithiation/delithiation potential, and
a plurality of particles made of a second anodic material having a high lithiation/delithiation potential, each said particle of said plurality of particles being encapsulated within a said cavity within said base,
said first anodic material and said second anodic material having a high electronic conductivities and a high lithium diffusivities.

7. The battery anode of claim 6 wherein each said cavity is sized substantially equivalent to or greater than the expanded size of said second anodic material particle positioned therein due to the particle being lithiated.

8. The battery anode of claim 6 wherein said first anodic material is magnesium.

9. The battery anode of claim 8 wherein said second anodic material is germanium.

10. The battery anode of claim 6 wherein said second anodic material is germanium.

11. A method of producing a battery anode comprising the steps of:
(a) preparing a quantity of a first anodic material having a first lithiation/delithiation potential;
(b) preparing a quantity of a particulated second anodic material having a second lithiation/delithiation potential greater than said first lithiation/delithiation potential of said base first anodic material;
(c) coating the particles of the second anodic material with a removable coating;
(d) mixing the second anodic material into the first anodic material to form a mixture of anodic material;
(e) forming an anodic layer with the mixture of anodic material, and
(f) removing the coating from the particles of the second anodic material within the anodic layer so as to form a cavity about the particles of the second anodic material in the area once occupied by the removed coating.

12. The method of claim 11 wherein step (f) each said cavity is sized substantially equivalent to or greater than the expanded size of said second anodic material particle positioned therein due to the particle being lithiated.

13. The method of claim 11 wherein step (a) the first anodic material is magnesium.

14. The method of claim 13 wherein step (b) the second anodic material is germanium.

15. The method of claim 11 wherein step (b) said second anodic material is germanium.

16. The method of claim 11 wherein the first anodic material and the second anodic material having a high electronic conductivities and a high lithium diffusivities.
